(19) United States
(12) Patent Application Publication
(10) Pub. No.: US 2013/0222103 A1
(43) Pub. Date: Aug. 29, 2013

(54) FERRITE CLAMP

(71) Applicant: Hideharu Kawai, Nagoya-shi (JP)

(72) Inventor: Hideharu Kawai, Nagoya-shi (JP)

(73) Assignee: Kitagawa Industries Co., Ltd., Nagoya-shi, Aichi (JP)

(21) Appl. No.: 13/882,576

(22) PCT Filed: Nov. 2, 2011
(86) PCT No.: PCT/JP2011/075336

§ 371 Date: Apr. 30, 2013

(30) Foreign Application Priority Data
Nov. 4, 2010 (JP) 2010-247320

(51) Int. Cl. H01F 27/02

(52) U.S. Cl. CPC H01F 27/02
USPC 336/175

(57) ABSTRACT

A ferrite clamp includes a pair of divided cores, each being formed in an open circular shape; and a pair of case parts, each being adapted to hold each of the divided cores. When the case parts are assembled with each other, the pair of divided cores held by the case parts constitute a circular magnetic core having an insertion hole to insert an electric cable therethrough. The case part includes, in a portion thereof to hold an outer peripheral surface of the divided core, a protruding portion which is outwardly convex.

### CROSS-REFERENCE TO RELATED APPLICATIONS

This international application claims the benefit of Japanese Patent Application No. 2010-247320 filed Nov. 4, 2010 in the Japan Patent Office, the disclosure of which is incorporated herein by reference.

### TECHNICAL FIELD

The present invention relates to a ferrite clamp that is, for example, attached to an electric cable of an electronic device or the like, to absorb a noise current, such as a noise current received by the electric cable as an antenna or a noise current generated externally and flowing into the electronic device through the electric cable.

### BACKGROUND ART

There is conventionally known a ferrite clamp as a device for absorbing noise flowing through an electric cable. The ferrite clamp includes a ferrite core which can be attached around the electric cable. The ferrite core is a magnetic body. A noise current flowing through the electric cable is absorbed by the ferrite core.

The aforementioned ferrite clamp includes, for example, a pair of plastic case parts. The ferrite core is fixed in the pair of plastic case parts. Specifically, a cylindrical ferrite core is axially divided into halves (hereinafter, each core after being divided is referred to as a divided core), and the divided cores are fit in the pair of plastic case parts connected with a hinge. The electric cable is clamped from outside of the electric cable by the divided cores together with the case parts. That is, the ferrite clamp of a type described above is attached in a middle of the electric cable (see Patent Documents 1 and 2).

### PRIOR ART DOCUMENT

### Patent Document

Patent Document 1: Japanese Unexamined Patent Application Publication No. 4-5804

Patent Document 2: Japanese Unexamined Utility Model Application Publication No. 3-59693

### SUMMARY OF THE INVENTION

### Problems To Be Solved By The Invention

There is a case where, in order to prevent a pair of case parts included in a ferrite clamp in a state of being attached to an electric cable from being separated from each other, outer peripheries of case parts P1 and P3 are secured with a clamping band P5 as shown in FIG. 8. A securing operation with the clamping band P5 is as described below.

(1) Inserting one end of the clamping band P5 into a locking member P7 provided at the other end of the clamping band P5.
(2) Inserting the case parts P1 and P3 of the ferrite clamp into a loop formed by the clamping band P5.
(3) Pulling the one end of the clamping band P5 opposite to the locking member P7 to thereby tighten the loop of the clamping band P5 and tighten the outer peripheries of the case parts P1 and P3 by the clamping band P5.

A configuration of the outer peripheries of the case parts is typically circular and outer peripheral surfaces of the case parts include no edge. In this case, when the one end of the clamping band is pulled, the loop of the clamping band rotates along the outer peripheries of the case parts, leading to poor workability.

Inside the case parts, in order to maintain a state where a pair of divided cores are joined, there are also provided resin springs that bias the divided cores toward respective opposite divided cores. To maintain the state where the pair of divided cores are joined firmly for a long time, it is required to increase a strength (a plate pressure) of the resin springs. When closing the pair of case parts, it is required to push the resin springs into the pair of case parts against the plate pressure of the resin springs. If the plate pressure of the resin spring is high, a large force is required to close the pair of case parts. For example, it may be difficult to close the pair of case parts with a single hand. In this case, workability when closing the pair of case parts will be lowered.

It is desirable to be able to solve at least one of the aforementioned problems.

### MEANS FOR SOLVING THE PROBLEMS

(1) A ferrite clamp in a first aspect of the present application includes a pair of divided cores, each being formed in an open circular shape; and a pair of case parts, each being adapted to hold each of the divided cores. When the case parts are assembled with each other, the pair of divided cores held by the case parts constitute a circular magnetic core having an insertion hole to insert an electric cable therethrough. The case part includes, in a portion thereof holding an outer peripheral surface of the divided core, a protruding portion which is outwardly convex.

In the ferrite clamp of the present invention, the case part includes, in the portion thereof to hold the outer peripheral surface of the divided core, the protruding portion which is outwardly convex. Accordingly, when the pair of case parts assembled together are tightened by the clamping band, the protruding portion becomes engaged with teeth-like convexes and concaves formed in the clamping band. As a result, when tightening the clamping band, the clamping band is suppressed from sliding and rotating on the outer peripheral surfaces of the pair of case parts, and thus an improved workability can be achieved.

The protruding portion is formed in an outer peripheral surface of the case part. The protruding portion may be configured as a convex portion protruding outward of the case part relative to a surrounding area, for example, as a protruding portion 19a in FIG. 1 and FIG. 3, or the protruding portion 41a in FIG. 6 and FIG. 7. Also, the protruding portion is not limited to such convex portion. For example, any portion having a shape (or configuration) capable of entering into a concave portion of the teeth-like convexes and concaves formed in the clamping band may be employed as the protruding portion. For example, the protruding portion may be configured as an end portion 37a (a corner of an end face of a plate-like member) in FIG. 5.

(2) A ferrite clamp in a second aspect of the present application includes a pair of divided cores, each being formed in an open circular shape; and a pair of case parts, each being adapted to hold each of the divided cores. When the case parts are assembled with each other, the pair of divided cores held by the case parts constitute a circular magnetic core having an insertion hole to insert an electric cable therethrough. The case part includes, in a portion thereof to hold an outer peripheral surface of the divided core, an elastically deformable portion which protrudes outwardly relative to a surrounding area and is inwardly elastically deformable. The elastically deformable portion, when elastically deformed inwardly, pushes one of the divided cores toward the other one of the divided cores.

The ferrite core of the present invention may include the above described elastically deformable portion. When the elastically deformable portion is tightened from outside by the clamping band, the elastically deformable portion is pushed inwardly, to thereby push one of the divided cores toward the other one of the divided cores. As a result, a joining pressure between the pair of divided cores is maintained, and an improved long-term reliability can be achieved.

Since the joining pressure between the pair of divided cores may be maintained by means of the aforementioned mechanism, it is not necessarily required to provide, inside the pair of case parts, a spring mechanism that generates a force to press the divided cores against each other. Even in case of providing a spring mechanism, the spring mechanism need not have a high spring pressure. As a result, only a small force is required to close the pair of case parts against the spring pressure of the spring mechanism when fitting together the pair of case parts.

(3) A ferrite clamp in a third aspect of the present application is the ferrite clamp in the second aspect, wherein the elastically deformable portion includes, in an outer peripheral surface thereof, a protruding portion which is outwardly convex.

In the ferrite clamp of the present invention, the elastically deformable portion includes, in the outer peripheral surface thereof, the protruding portion which is outwardly convex. Accordingly, when the pair of case parts assembled together are tightened by the clamping band, the protruding portion becomes engaged with teeth-like convexes and concaves formed in the clamping band. As a result, when tightening the clamping band, the clamping band is suppressed from sliding and rotating on the outer peripheral surfaces of the pair of case parts, and thus an improved workability can be achieved.

The protruding portion may be configured as a convex portion protruding outward of the case part relative to a surrounding area, for example, as a protruding portion 19a in FIG. 1 and FIG. 3, or the protruding portion 41a in FIG. 6 and FIG. 7. Also, the protruding portion is not limited to such convex portion. For example, any portion, which has a shape (or configuration) capable of entering into a concave portion of the teeth-like convexes and concaves formed in the clamping band, may be employed as the protruding portion. For example, the protruding portion may be configured as an end portion 37a (a corner of an end face of a plate-like member) in FIG. 5.

(4) A ferrite clamp in a fourth aspect of the present application is the ferrite clamp in the second aspect or the third aspect, further including, in an outer peripheral surface of the case part, a guide portion to guide a clamping band at a path passing over the elastically deformable portion.

By including the guide portion, the ferrite clamp of the present invention may guide the clamping band to an appropriate position (such as a position of passing over the elastically deformable portion and going around the outer peripheries of the pair of case parts).

Hereinafter, embodiments of the present invention will be described with reference to the drawings.

### BRIEF DESCRIPTION OF THE DRAWINGS

FIG. 1 is a perspective view of an entire ferrite clamp 1.

FIG. 2 is a side cross-sectional view showing a case part 5a and a divided core 3a.

FIG. 3 is a side cross-sectional view of the ferrite clamp 1.

FIG. 4A is an explanatory view showing a method for tightening the ferrite clamp 1 with a clamping band 31 and also showing a state where the ferrite clamp 1 has not yet been tightened with the clamping band 31.

FIG. 4B is an explanatory view showing the method for tightening the ferrite clamp 1 with the clamping band 31 and also showing a state where the ferrite clamp 1 has been tightened with the clamping band 31.

FIG. 5 is a perspective view showing an elastically deformable portion 11a.

FIG. 6 is a perspective view showing an elastically deformable portion 11a.

FIG. 7 is a perspective view showing an elastically deformable portion 11a.

FIG. 8 is an explanatory view showing a method for securing a conventional ferrite clamp.

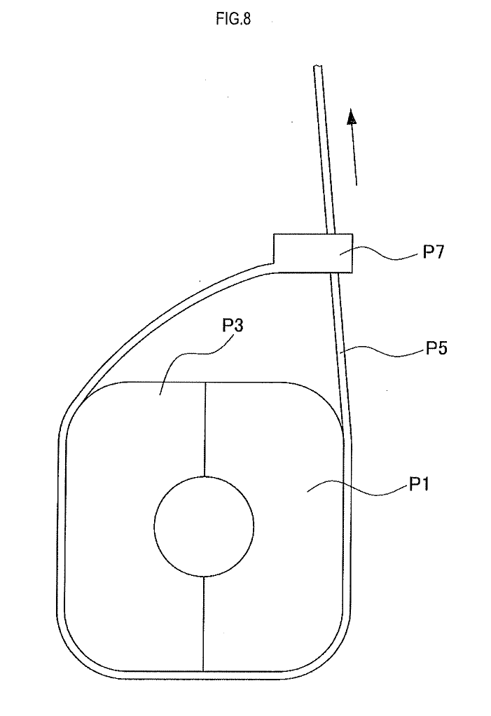

### EXPLANATION OF REFERENCE NUMERALS

1 . . . ferrite clamp, 3a, 3b . . . divided core, 5a, 5b . . . case part, 6a, 6b . . . projection, 7a, 7b . . . side wall portion, 8a, 8b . . . groove, 9a . . . opening, 10a, 10b . . . outer peripheral surface, 11a, 13a, 11b, 13b . . . elastically deformable portion, 12 . . . through hole, 15a . . . cutout, 17a . . . connection side, 19a, 20a, 19b, 20b . . . protruding portion, 21a, 23a . . . guide plate, 25 . . . insertion hole, 27 . . . magnetic core, 29 . . . electric cable, 31 . . . clamping band, 33a . . . sloping portion, 35a . . . flat portion, 37a . . . end portion, 39a . . . protruding portion, 41a . . . protruding portion, 43a . . . band insertion hole, P1, P3 . . . case part, P5 . . . clamping band, P7 . . . locking member

### MODE FOR CARRYING OUT THE INVENTION

### First Embodiment

1. Configuration of Ferrite Clamp 1

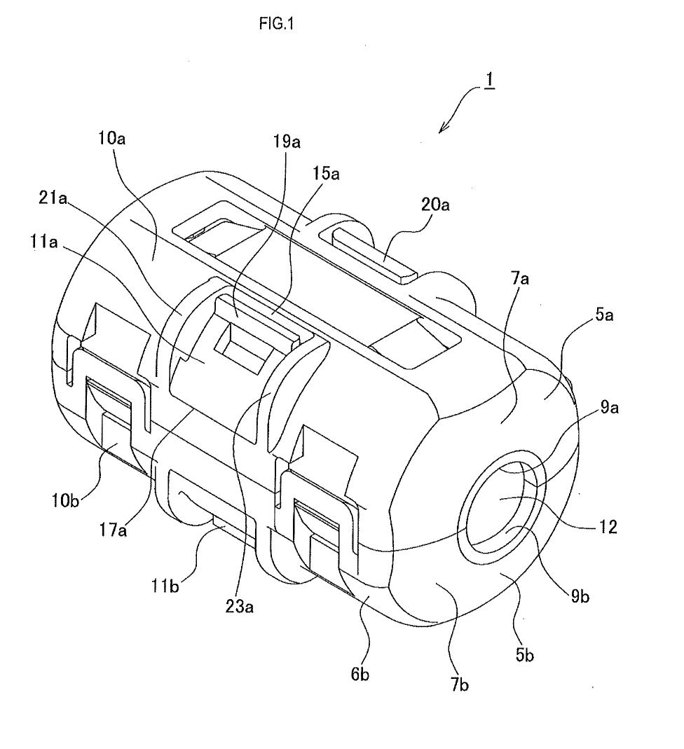

A configuration of a ferrite clamp 1 will be described based on FIG. 1 to FIG. 3.

The ferrite clamp 1 includes a pair of divided cores 3a and 3b, each of which has an open circular shape, and a pair of case parts 5a and 5b to hold divided cores 3a and 3b, respectively.

The case parts 5a and 5b as a whole form a case having a cylindrical shape. The case parts 5a and 5b are formed of thin members. An elastic resin is employed for the members. Also, the case parts 5a and 5b are formed such that the case having the cylindrical shape can be divided along a plane including a central axis of the cylindrical shape.

Divided cores 3a and 3b are fit in the case parts 5a and 5b, respectively. Projections 6a and 6b are formed in respective inner peripheral surfaces of the respective case parts 5a and 5b. In respective outer peripheral surfaces of the divided cores 3a and 3b, there are provided grooves 8a and 8b corresponding respectively to the projections 6a and 6b of the case parts 5a and 5b. When fitting the divided core 3a in the case part 5a, the projection 6a and the groove 8a are engaged with each other, to thereby stabilize a position of the divided core 3a. Also, when fitting the divided core 3b in the case part 5b, the projection 6b and the groove 8b are engaged with each other, to thereby stabilize a position of the divided core 3b.

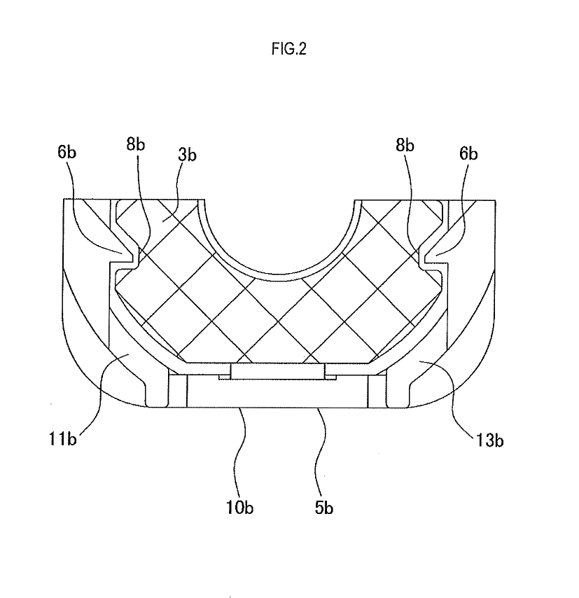

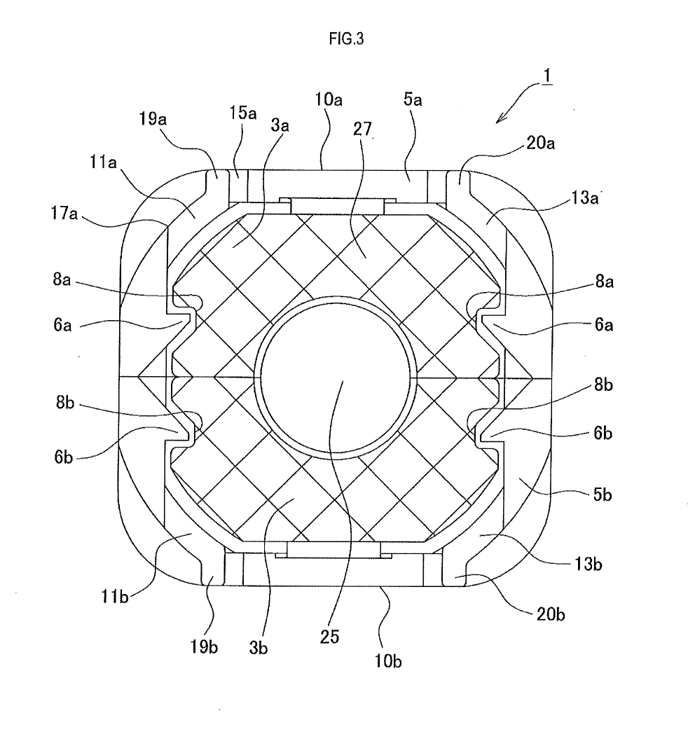

At both ends of the case parts 5a and 5b in an axial direction (i.e., in a direction perpendicular to a paper surface of FIG. 2 or FIG. 3), there are provided side wall portions 7a and 7b perpendicular to the axial direction. The side wall portions 7a and 7b are provided with semicircular openings 9a and 9b, respectively. The openings 9a and 9b constitute a substantially circular through hole 12 when the case parts 5a and 5b are closed as shown in FIG. 1.

Elastically deformable portions 11a and 13a are provided in an outer peripheral surface 10a of the case part 5a. The outer peripheral surface 10a is a portion to hold the outer peripheral surface of the divided core 3a. Elastically deformable portions 11b and 13b are provided in an outer peripheral surface 10b of the case part 5b. The outer peripheral surface 10b is a portion to hold the outer peripheral surface of the divided core 3b. The elastically deformable portions 11a, 13a, 11b, and 13b have an essentially same configuration. Here, the configuration will be described taking the elastically deformable portion 11a as an example.

The elastically deformable portion 11a is formed by providing a substantially U-shaped cutout 15a in the case part 5a. That is, a portion defined by the cutout 15a constitutes the elastically deformable portion 11a. The elastically deformable portion 11a is connected to a main body of the case part 5a only at a connecting side 17a thereof. The elastically deformable portion 11a as a whole has a plate-like shape and is deflectable. The connecting side 17a is parallel to a longitudinal central axis of the case part 5a. Also, the connecting side 17a is located closer to an abutting region between the case part 5a and the case part 5b than the cutout 15a. At an opposite side to the connecting side 17a of the elastically deformable portion 11a, there is formed a protruding portion 19a having an outwardly convex shape. In a cross-section shown in FIG. 3, the protruding portion 19a is located between a top of the case part 5a (an uppermost part in FIG. 3) and a portion of the case part 5a abutting the case part 5b.

When the protruding portion 19a is pressed inwardly from outside of the case part 5a, the elastically deformable portion 11a is pushed into the case part 5a (elastically deformed). The protruding portion 19a has such a size that the protruding portion 19a enters into teeth-like convexes and concaves provided in a below described clamping band 31 and is caught by the convexes and concaves. The elastically deformable portions 13a, 11b, and 13b are also formed in a same manner as the elastically deformable portion 11a. The elastically deformable portions 13a, 11b, and 13b include protruding portions 20a, 19b, and 20b, respectively, which are the same as the protruding portion 19a.

The case part 5a also includes a pair of guide plates 21a and 23a standing so as to sandwich the connecting side 17a and the protruding portion 19a of the elastically deformable portion 11a from both sides thereof.

As shown in FIG. 1 and FIG. 3, when the case part 5a holding the divided core 3a and the case part 5b holding the divided core 3b are fit together, the divided cores 3a and 3b constitute a circular magnetic core 27 having an insertion hole 25 for inserting an electric cable therethrough. Also, the case parts 5a and 5b constitute an integrated case, which contains thereinside the magnetic core 27. The insertion hole 25 of the magnetic core 27 and the through hole 12 formed by the case parts 5a and 5b are coaxially aligned. Then, it is possible to insert an electric cable through the insertion hole 25 and the through hole 12.

A material for the divided cores 3a and 3b is a publicly known ferrite. The divided cores 3a and 3b may be formed into the aforementioned configuration by means of a publicly known forming method.

2. Method for Use of Ferrite Clamp 1

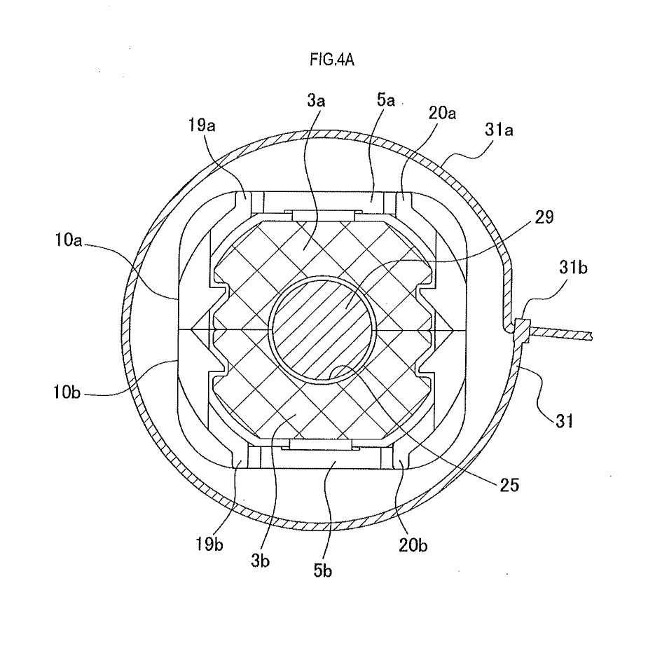

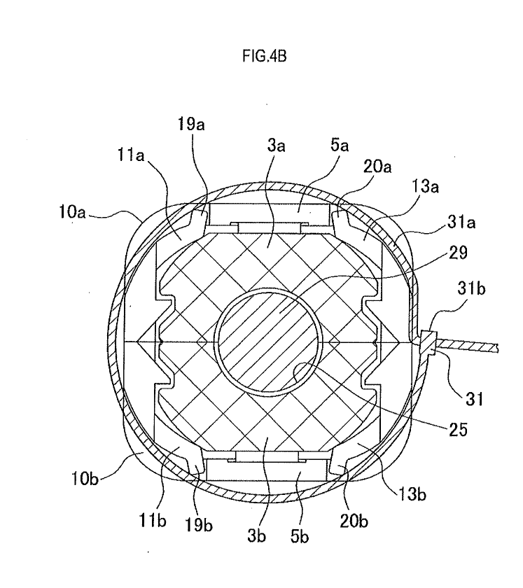

A method for use of a ferrite clamp 1 will now be described based on FIG. 4A to FIG. 4B.

The ferrite clamp 1 is first assembled from a state where the case part 5a holding the divided core 3a and the case part 5b holding the divided core 3b are separated into a state shown in FIG. 4A.

Specifically, the case parts 5a and 5b are fit together such that an electric cable 29 passes through the insertion hole 25. Then, the clamping band 31 is wound so as to go around along the outer peripheral surface 10a of the case part 5a as well as the outer peripheral surface 10b of the case part 5b.

Subsequently, as shown in FIG. 4B, a loop of the clamping band 31 is tightened. Specifically, the case parts 5a and 5b are tightened from outside thereof with the clamping band 31. In this case, a path of the clamping band 31 is a path which passes over the elastically deformable portions 11a, 13a, 11b, and 13b, and goes around the outer peripheral surface 10a of the case part 5a as well as the outer peripheral surface 10b of the case part 5b. Also, the clamping band 31 may be arranged so as to pass between the pair of guide plates (the guide plates 21a and 23a with respect to the elastically deformable portion 11a) provided on respective both sides of the elastically deformable portions 11a, 13a, 11b, and 13b.

The clamping band 31 is a well-known one which is also referred to as a cable tie or a nylon tie. Examples of the clamping band 31 include products named Ty-Rap (Registered Trademark) and INSULOK (Registered Trademark). The clamping band 31 includes a belt-like band 31a and a locking member 31b provided at one end of the band 31a. As the other end (an end without the locking member) of the band 31a is inserted through the locking member 31b, the loop formed by the band 31a can be tightened. A surface of the band 31a includes the teeth-like convexes and concaves (not shown) formed in a large number at predetermined intervals along a longitudinal direction of the band 31a. The teeth-like convexes and concaves are adapted to prevent the band 31a that has passed the locking member 31b from returning in a reverse direction.

When the case parts 5a and 5b are tightened by the clamping band 31, the protruding portion 19a of the elastically deformable portion 11a is pushed inwardly by a tightening force of the clamping band 31 as shown in FIG. 4B. Then, the elastically deformable portion 11a is elastically deformed inwardly and abuts the divided core 3a, to thereby push the divided core 3a toward the divided core 3b. In a same manner, the elastically deformable portion 13a is elastically deformed inwardly by the tightening force by the clamping band 31 and abuts the divided core 3a, to thereby push the divided core 3a toward the divided core 3b. Also, the elastically deformable portions 11b and 13b are elastically deformed inwardly by the tightening force by the clamping band 31 and abut the divided core 3b, to thereby push the divided core 3b toward the divided core 3a.

3. Advantages Realized by Ferrite Clamp 1

(1) The ferrite clamp 1 includes the protruding portions 19a, 20a, 19b, and 20b, each having an outwardly convex shape, in the outer peripheral surfaces 10a and 10b of the case parts 5a and 5b. When the case parts 5a and 5b are tightened by the clamping band 31, the protruding portions 19a, 20a, 19b, and 20b are engaged with the teeth-like convexes and concaves formed in the clamping band 31. As a result, when tightening the clamping band 31, the clamping band 31 is suppressed from sliding and rotating on the outer peripheral surfaces 10a and 10b of the case parts 5a and 5b, and thus an improved workability can be achieved.

(2) When the case parts 5a and 5b are tightened by the clamping band 31, the elastically deformable portion 11a and the elastically deformable portion 13a are pushed inwardly, to thereby push the divided core 3a toward the divided core 3b as shown in FIG. 4B. Also, the elastically deformable portion 11b and the elastically deformable portion 13b are pushed inwardly, to thereby push the divided core 3b toward the divided core 3a. As a result, a joining pressure between the divided cores 3a and 3b is maintained, and a long-term reliability can be ensured.

In addition, since the joining pressure between the divided cores 3a and 3b can be maintained by means of the aforementioned mechanism, it is not necessarily required to provide, inside the case parts 5a and 5b, some spring mechanism (such as a resin spring, a metal spring, and the like) that generates a force to to thereby push the divided cores 3a and 3b against each other. Even in case of providing a spring mechanism, the spring mechanism need not have a high spring pressure. As a result, only a small force is required to close the case parts 5a and 5b against the spring pressure of the spring mechanism when fitting the case parts 5a and 5b together.

### Second Embodiment

1. Configuration of Ferrite Clamp 1 and Method for Use Thereof

The ferrite clamp 1 in a second embodiment has essentially the same configuration as the ferrite clamp 1 in the first embodiment. However, the ferrite clamps 1 in these two embodiments are different in terms of configurations of the elastically deformable portions 11a, 13a, 11b, and 13b. The following description will focus mainly on the differences, and explanations of the same portions as in the above-described embodiment will be omitted or simplified.

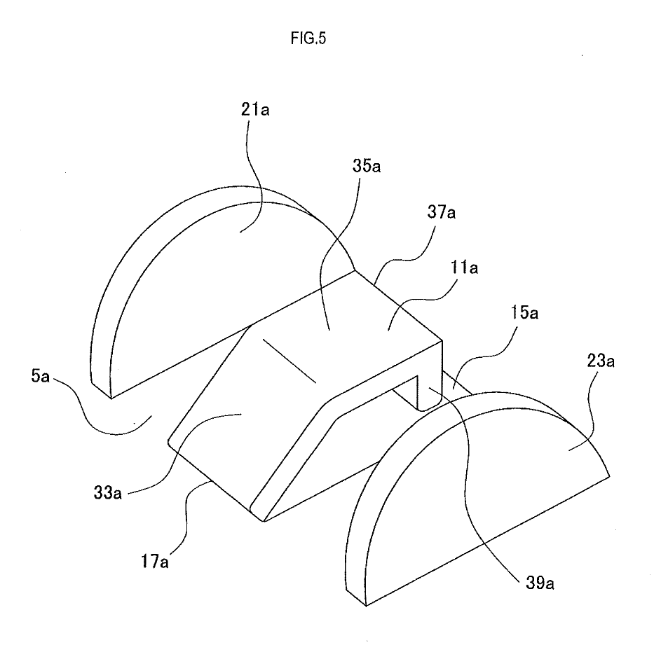

The configuration of the elastically deformable portion 11a in the second embodiment will be described based on FIG. 5. The elastically deformable portions 13a, 11b, and 13b have the same configuration as the elastically deformable portion 11a. Also, locations at which the elastically deformable portions 11a, 13a, 11b, and 13b are provided are the same as in the first embodiment.

The elastically deformable portion 11a is formed by providing a substantially U-shaped cutout 15a in the case part 5a. That is, a portion defined by the cutout 15a constitutes the elastically deformable portion 11a. The elastically deformable portion 11a is connected to the main body of the case part 5a only at the connecting side 17a. The elastically deformable portion 11a as a whole has a plate-like shape and is deflectable. The connecting side 17a is parallel to the longitudinal central axis of the case part 5a. Also, the connecting side 17a is located closer to the abutting region between the case part 5a and the case part 5b than the cutout 15a. The elastically deformable portion 11a includes the sloping portion 33a and the flat portion 35a. The sloping portion 33a is a portion of the elastically deformable portion 11a configured to gradually depart from the case part 5a beginning at the connecting side 17a. The flat portion 35a is a portion formed in a flat manner and in connection with the sloping portion 33a. The flat portion 35a is arranged at a position extending outwardly from the case part 5a. An end portion 37a of the flat portion 35a located opposite to the connecting side 17a forms an acute corner and is engageable with the teeth-like convexes and concaves formed in the clamping band 31. At the end portion 37a on a reverse side of the flat portion 35a, a protruding portion 39a protruding downwardly is formed. When the flat portion 35a is pressed inwardly by a tightening force by the clamping band 31, the elastically deformable portion 11a is pushed into the case part 5a (elastically deformed). Then, the protruding portion 39a to thereby pushes the divided core 3a toward the divided core 3b. The elastically deformable portion 13a, 11b, and 13b are also configured in the same manner as the elastically deformable portion 11a.

The case part 5a also includes the pair of guide plates 21a and 23a standing so as to sandwich the elastically deformable portion 11a from both sides thereof. The guide plates 21a and 23a guide the clamping band 31 such that the clamping band 31 passes over the elastically deformable portion 11a.

2. Advantages Realized by Ferrite Clamp 1

(1) The ferrite clamp 1 includes the end portion 37a of the elastically deformable portion 11a in the outer peripheral surfaces 10a and 10b of the case parts 5a and 5b. Also included are not-shown end portions, which are the same as the end portion 37a, provided in the elastically deformable portions 13a, 11b, and 13b. Hereinafter, such end portions are also referred to as end portions of the elastically deformable portions 13a, 11b, and 13b.

When tightening the case parts 5a and 5b by the clamping band 31, the end portions of the elastically deformable portions 11a, 13a, 11b and 13b become engaged with the teeth-like convexes and concaves formed in the clamping band 31. As a result, when tightening the clamping band 31, the clamping band 31 is suppressed from sliding and rotating on the outer peripheral surfaces 10a and 10b of the case parts 5a and 5b, and thus an improved workability can be achieved.

(2) When the case parts 5a and 5b are tightened by the clamping band 31, the elastically deformable portion 11a and the elastically deformable portion 13a are pushed inwardly, to thereby push the divided core 3a toward the divided core 3b. Also, the elastically deformable portion 11b and the elastically deformable portion 13b are pushed inwardly, to thereby push the divided core 3b toward the divided core 3a. As a result, a joining pressure between the divided cores 3a and 3b is maintained, and a long-term reliability can be ensured.

In addition, since the joining pressure between the divided cores 3a and 3b can be maintained by means of the aforementioned mechanism, it is not necessarily required to provide, inside the case parts 5a and 5b, some spring mechanism that generates a force to thereby push the divided cores 3a and 3b against each other. Even in case of providing a spring mechanism, the spring mechanism need not have a high spring pressure. As a result, only a small force is required to close the case parts 5a and 5b against the spring pressure of the spring mechanism when fitting the case parts 5a and 5b together.

### Third Embodiment

1. Configuration of Ferrite Clamp 1 and Method for Use Thereof

The ferrite clamp 1 in a third embodiment has essentially the same configuration as the ferrite clamp 1 in the first embodiment. However, the ferrite clamps 1 in these two embodiments are different in terms of configurations of the elastically deformable portions 11a, 13a, 11b, and 13b. The following description will focus mainly on the differences, and explanations of the same portions as in the above-described embodiment will be omitted or simplified.

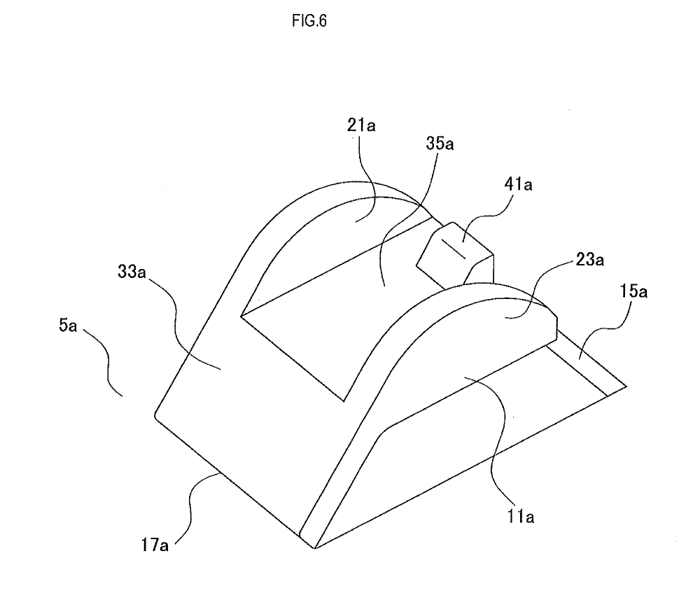

The configuration of the elastically deformable portion 11a in the third embodiment will be described based on FIG. 6. The elastically deformable portions 13a, 11b, and 13b have the same configuration as the elastically deformable portion 11a. Also, locations at which the elastically deformable portions 11a, 13a, 11b, and 13b are provided are the same as in the first embodiment.

The elastically deformable portion 11a is formed by providing a substantially U-shaped cutout 15a in the case part 5a. That is, a portion defined by the cutout 15a constitutes the elastically deformable portion 11a. The elastically deformable portion 11a is connected to the main body of the case part 5a only at the connecting side 17a. The connecting side 17a is parallel to the longitudinal central axis of the case part 5a. Also, the connecting side 17a is located closer to the abutting region between the case part 5a and the case part 5b than the cutout 15a. The elastically deformable portion 11a includes the sloping portion 33a and the flat portion 35a. The sloping portion 33a is a portion of the elastically deformable portion 11a configured to gradually depart from the case part 5a beginning at the connecting side 17a. The flat portion 35a is a portion formed in a flat manner and in connection with the sloping portion 33a. The flat portion 35a is arranged at a position extending outwardly from the case part 5a. At an end portion of the flat portion 35a opposite to the connecting side 17a, a protruding portion 41a which is outwardly convex is formed. When the protruding portion 41a is pressed inwardly from outside, the elastically deformable portion 11a is pushed into the case part 5a (elastically deformed). The protruding portion 41a has such a size that the protruding portion 41a enters into teeth-like convexes and concaves formed in the clamping band 31 and is caught by the convexes and concaves. The elastically deformable portions 13a, 11b, and 13b are also formed in the same manner as the elastically deformable portion 11a. In the third embodiment, the guide plates 21a and 23a are provided on both sides of the flat portion 35a. The guide plates 21a and 23a sandwich the clamping band 31 passing over the flat portion 35a from both sides thereof, and guide the clamping band 31.

When the flat portion 35a is pushed inwardly with the clamping band 31, the elastically deformable portion 11a is elastically deformed and pushed into the case part 5a, pushing the divided core 3a toward the divided core 3b. The elastically deformable portions 13a, 11b, and 13b are also configured in the same manner as the elastically deformable portion 11a.

2. Advantages Realized by the Ferrite Clamp 1

(1) The ferrite clamp 1 includes the protruding portion 41a of the elastically deformable portion 11a in the outer peripheral surfaces 10a and 10b of the case parts 5a and 5b. Also included are not-shown protruding portions, which are the same as the protruding portion 41, provided in the elastically deformable portion 13a, 11b, and 13b. Hereinafter, such protruding portions are also referred to as protruding portions of the elastically deformable portions 13a, 11b, and 13b.

When tightening the case parts 5a and 5b by the clamping band 31, the end portions of the elastically deformable portions 11a, 13a, 11b and 13b become engaged with the teeth-like convexes and concaves formed in the clamping band 31. As a result, when tightening the clamping band 31, the clamping band 31 is suppressed from sliding and rotating on the outer peripheral surfaces 10a and 10b of the case parts 5a and 5b, and thus an improved workability can be achieved.

(2) When the case parts 5a and 5b are tightened by the clamping band 31, the elastically deformable portion 11a and the elastically deformable portion 13a are pushed inwardly, to thereby push the divided core 3a toward the divided core 3b. Also, the elastically deformable portion 11b and the elastically deformable portion 13b are pushed inwardly, to thereby push the divided core 3b toward the divided core 3a. As a result, a joining pressure between the divided cores 3a and 3b is maintained, and a long-term reliability can be ensured.

In addition, since the joining pressure between the divided cores 3a and 3b can be maintained by means of the aforementioned mechanism, it is not necessarily required to provide, inside the case parts 5a and 5b, some spring mechanism that generates a force to press the divided cores 3a and 3b against each other. Even in case of providing a spring mechanism, the spring mechanism need not have a high spring pressure. As a result, only a small force is required to close the case parts 5a and 5b against the spring pressure of the spring mechanism when fitting the case parts 5a and 5b together.

### Fourth Embodiment

1. Configuration of Ferrite Clamp 1 and Method for Use Thereof

The ferrite clamp 1 in a fourth embodiment has essentially the same configuration as the ferrite clamp 1 in the first embodiment. However, the ferrite clamps 1 in these two embodiments are different in terms of configurations of the elastically deformable portions 11a, 13a, 11b, and 13b. The following description will focus mainly on the differences, and explanations of the same portions as in the above-described embodiment will be omitted or simplified.

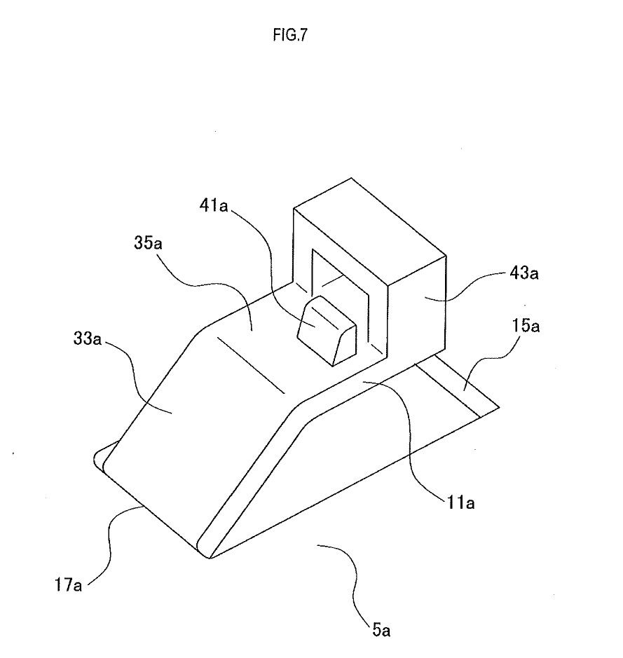

The configuration of the elastically deformable portion 11a in the fourth embodiment will be described based on FIG. 7. The elastically deformable portions 13a, 11b, and 13b have the same configuration as the elastically deformable portion 11a. Also, locations at which the elastically deformable portions 11a, 13a, 11b, and 13b are provided are the same as in the first embodiment.

The elastically deformable portion 11a is formed by providing a substantially U-shaped cutout 15a in the case part 5a. That is, a portion defined by the cutout 15a constitutes the elastically deformable portion 11a. The elastically deformable portion 11a is connected to the main body of the case part 5a only at the connecting side 17a. The connecting side 17a is parallel to the longitudinal central axis of the case part 5a. Also, the connecting side 17a is located closer to the abutting region between the case part 5a and the case part 5b than the cutout 15a. The elastically deformable portion 11a includes the sloping portion 33a and the flat portion 35a. The sloping portion 33a is a portion of the elastically deformable portion 11a configured to gradually depart from the case part 5a beginning at the connecting side 17a. The flat portion 35a is a portion formed in a flat manner and in connection with the sloping portion 33a. The flat portion 35a is arranged at a position extending outwardly from the case part 5a. In a vicinity of a center of the flat portion 35a, a protruding portion 41a which is outwardly convex is formed. When the protruding portion 41a is pressed inwardly from outside, the elastically deformable portion 11a is elastically deformed and is pushed into the case part 5a. The protruding portion 41a has such a size that the protruding portion 41a enters into teeth-like convexes and concaves formed in the clamping band 31 and is caught by the convexes and concaves. At an end portion of the flat portion 35a located opposite to the sloping portion 33a, a band insertion hole 43a having a gate-like shape is formed. The band insertion hole 43a is adapted to insert therethrough the clamping band 31, which passes over the flat portion 35a, to thereby guide the clamping band 31.

When the flat portion 35a is pressed inwardly from outside by the clamping band 31, the elastically deformable portion 11a is elastically deformed and pushed into the case part 5a, to thereby push the divided core 3a toward the divided core 3b. The elastically deformable portion 13a, 11b, and 13b are also configured in the same manner as the elastically deformable portion 11a.

2. Advantages Realized by the Ferrite Clamp 1

(1) The ferrite clamp 1 includes the protruding portion 41a of the elastically deformable portion 11a in the outer peripheral surfaces 10a and 10b of the case parts 5a and 5b. Also included are not-shown protruding portions, which are the same as the protruding portion 41, in the elastically deformable portion 13a, 11b, and 13b. Hereinafter, such protruding portions are also referred to as the protruding portions of the elastically deformable portions 13a, 11b, and 13b.

When tightening the case parts 5a and 5b by the clamping band 31, the protruding portions of the elastically deformable portions 11a, 13a, 11b and 13b become engaged with the teeth-like convexes and concaves formed in the clamping band 31. As a result, when tightening the clamping band 31, the clamping band 31 is suppressed from sliding and rotating on the outer peripheral surfaces 10a and 10b of the case parts 5a and 5b, and thus an improved workability can be achieved.

(2) When the case parts 5a and 5b are tightened by the clamping band 31, the elastically deformable portion 11a and the elastically deformable portion 13a are pushed inwardly, to thereby push the divided core 3a toward the divided core 3b. Also, the elastically deformable portion 11b and the elastically deformable portion 13b are pushed inwardly, to thereby push the divided core 3b toward the divided core 3a. As a result, a joining pressure between the divided cores 3a and 3b is maintained, and a long-term reliability can be ensured.

Further, since the joining pressure between the divided cores 3a and 3b can be maintained by means of the aforementioned mechanism, it is not necessarily required to provide, inside the case parts 5a and 5b, some spring mechanism that generates a force to press the divided cores 3a and 3b against each other. Even in case of providing a spring mechanism, the spring mechanism need not have a high spring pressure. As a result, only a small force is required to close the case parts 5a and 5b against the spring pressure of the spring mechanism when fitting the case parts 5a and 5b together.

It is needless to say that the present invention should not be limited to the above described embodiments, but may be practiced in various forms within the scope not departing from the present invention.

For example, the elastically deformable portion may be provided in only one of the case parts 5a and 5b.

Also, the number of the elastically deformable portions provided in the case part 5a is not limited to two, but may be, for example, one, three, five, etc. The same is applicable to the case part 5b.

Moreover, the case parts 5a and 5b may be completely separable from each other, or may be joined with a hinge to be openable and closable.

1. (canceled)

2. A ferrite clamp comprising:
a pair of divided cores, each being formed in an open circular shape; and
a pair of case parts, each being adapted to hold each of the divided cores,
wherein when the case parts are assembled with each other, the pair of divided cores held by the case parts constitute a circular magnetic core having an insertion hold to insert an electric cable therethrough,
the case part includes, in a portion thereof to hold an outer peripheral surface of the divided core, an elastically deformable portion which protrudes outwardly relative to a surrounding area and is inwardly elastically deformable, and
the elastically deformable portion, when elastically deformed inwardly, pushes one of the divided cores toward the other one of the divided cores.

3. The ferrite clamp according to claim 2, wherein the elastically deformable portion includes, in an outer peripheral surface thereof, a protruding portion which is outwardly convex.

4. The ferrite clamp according to claim 2, further comprising, in an outer peripheral surface of the case part, a guide portion to guide a clamping band at a path passing over the elastically deformable portion.

5. The ferrite clamp according to claim 3, further comprising, in an outer peripheral surface of the case part, a guide portion to guide a clamping band at a path passing over the elastically deformable portion.
